(19) United States
(12) Patent Application Publication
(10) Pub. No.: US 2025/0121869 A1
(43) Pub. Date: Apr. 17, 2025

(54) DOOR SUPPORTING APPARATUS

(71) Applicant: Adam Conley, Vancouver, WA (US)

(72) Inventor: Adam Conley, Vancouver, WA (US)

(21) Appl. No.: 18/485,158

(22) Filed: Oct. 11, 2023

(51) Int. Cl. B62B 3/10; B62B 3/06; B62B 5/04

(52) U.S. Cl. CPC B62B 3/108; B62B 3/0637; B62B 5/0438; B62B 5/0457; B62B 2203/10

(57) ABSTRACT

Disclosed are a door supporting apparatus and method of using same. While a heavy door is loaded to the door supporting apparatus, the door supporting apparatus may be rotatable between horizontal and vertical orientations to enable safe handling of the heavy door for serving and/or repairs.

### FIELD

This disclosure relates generally to tools and/or apparatuses to facilitate handling of commercial and/or industrial doors.

### Information:

Techniques to repair large industrial doors, such as doors for commercial walk-in freezers and/or refrigerators, typically include removal of a door from its hinges and placing the detached door on a floor space near the door opening. Furthermore, having repairman and/or technicians engage with a detached door on a floor may run the risk of injury. Additionally, constraining repairs on a large detached door to a floor space local to a door opening may be highly inefficient. Also, damage can occur to such a door in the process of removing the door from hinges. Additionally, injury can occur if the door if the workers lose control of the door while it is removed from hinges.

Once removed from hinges, a large industrial door may also be lifted onto a workbench to facilitate repairs. With the typical walk in refrigerator door weighing up to 300 pounds, lifting the walk in refrigerator door onto a work bench with even two men may be infeasible. Even once the walk in refrigerator door is brought onto a workbench, it may be difficult to move the door while on the workbench to facilitate access to portions of the door needing repair.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may be best understood by reference to the following detailed description if read with the accompanying drawings in which:

FIGS. 1A, 1B, 1C, 1D and 1E are schematic diagrams of a door supporting apparatus, according to an embodiment;

FIGS. 2A and 2B are side views of a door supporting apparatus according to an embodiment;

FIGS. 3A, 3B and 3C are schematic diagrams of features of a pulley system for a foot lift, according to an embodiment;

FIGS. 4A, 4B, 4C, 4D and 4E are schematic diagrams of a foot lift, according to an embodiment;

FIGS. 5A through 5F are schematic diagrams of features of a brake system, according to an embodiment; and

FIGS. 6A through 6D are schematic diagrams of features of a support arm assembly, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

Particular embodiments disclosed herein relate to techniques for the removal, transportation, repair, and or reinstallation of large industrial doors such as, for example, doors to a commercial walk-in freezer and/or refrigerator.

According to an embodiment, a door supporting apparatus may be moved between horizontal and vertical orientations while loaded with a large commercial and/or industrial door. This may enable a convenient removal of the large commercial and/or industrial door from its hinges and placement of the detached commercial and/or industrial door in a position that enhances efficiency in repair operations as well as reduces the likelihood of injury to workers performing repairs on the detached door.

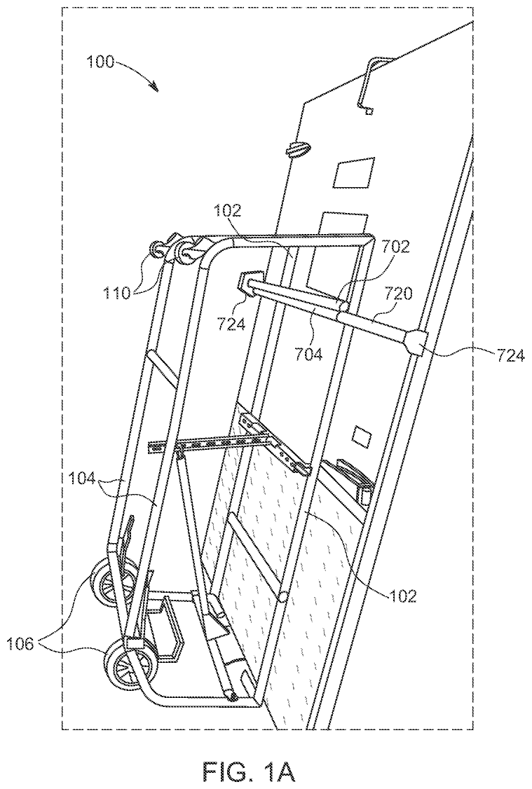

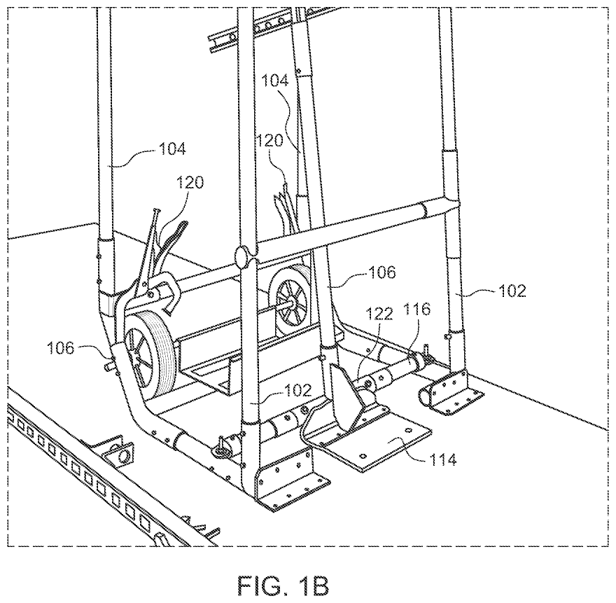

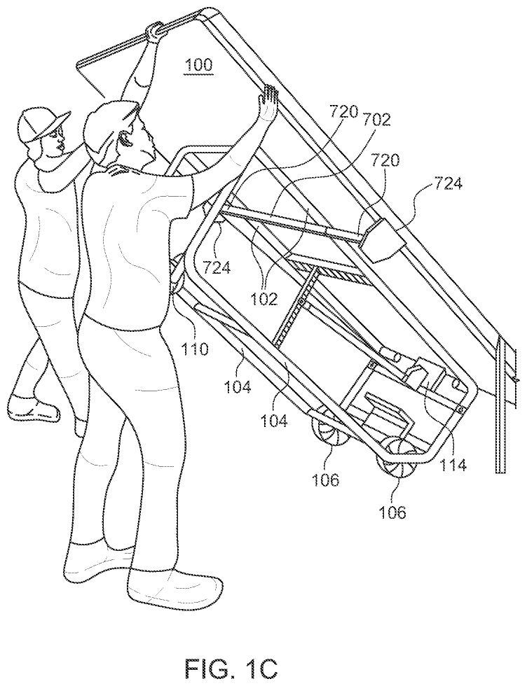

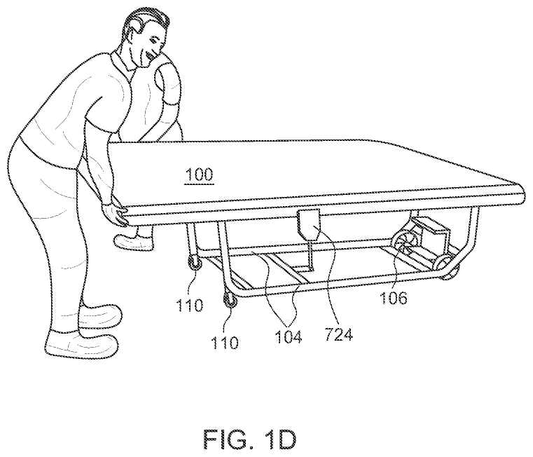

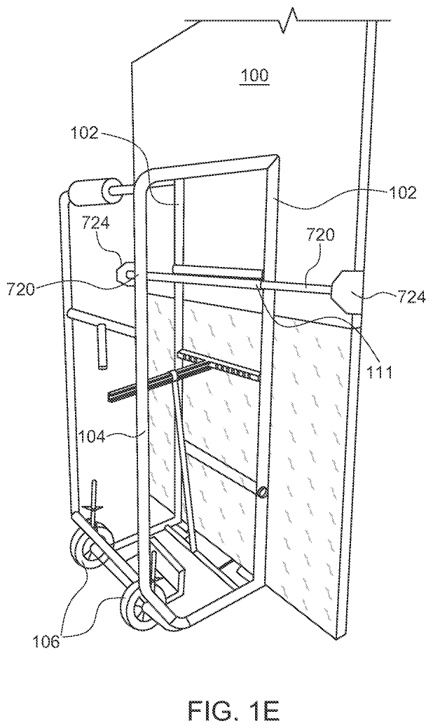

FIG. 1A shows a door supporting apparatus according to an embodiment. A carriage body includes a metal frame comprising frame members. As shown, the door supporting apparatus is capable of holding a large door 100, such as a door to a commercial refrigerator weighing 200 pounds or more, in a vertical position while door 100 detached from hinges (as shown). The carriage body includes first frame members 102 which may be placed against the face of large door 100 while in a vertical position as shown. According to an embodiment, the carriage body including frame members 102 and 104 may be formed from any metal piping a suitable strength and weight including, for example, steel or aluminum tubing. In an implementation, the carriage body may be assembled from tubing members by bending and/or welding joints using techniques known to those of ordinary skill in the art. According to an embodiment, mounting plates may be welded to frame members (e.g., frame members 102 and/or 104) to facilitate attachment of accessories (e.g., lift or brake assemblies and components, casters, wheels, etc.) by bolts. This may enable access to and/or replacement of such accessories if they become worn or damaged. The carriage body may be formed and shaped using spot welds and shaping using techniques down to those of ordinary skill in the art.

Wheels 106 mounted to the carriage body may enable the carriage body to be rotated while large door 100 is placed on and/or secured against first member frame members 102 so that large door 100 is horizontally oriented (as shown in FIG. 1D). While FIGS. 1A through 1E show mounting of wheels 106 to be disposed on the inside of frame members 104, in other embodiments wheels 106 may be mounted to be disposed on the outside of frame members 104, According to an embodiment, casters 110 may be fastened to mounting plates (e.g., welded to frame members of the carriage body) by bolts, and may be conveniently replaced by unbolting, etc. As shown in FIG. 1C, wheels 106 may be locked while the carriage body and large door 100 are rotated together about the locked (e.g., by brakes 120) wheels 106 in contact with a floor from a vertical orientation to a horizontal orientation with wheels 106 and casters 110 in contact with the floor. Locking wheels 106 using brakes 120 while rotating the door supporting apparatus to the horizontal orientation may reduce the risk of door 100 and the door supporting apparatus from “rolling out from under.” This may significantly reduce the risk of workers losing control of a large heavy door while positioning the large heavy door for maintenance and/or repairs, for example. Here, large door 100 may be maintained in a horizontal orientation to enable maintenance and/or repairs to be performed by technicians, repairmen, etc. Additionally, while the door supporting apparatus is supported against the floor by wheels 106 and casters 110, wheels 106 may be unlocked (e.g., by release of brakes 120) to enable the carriage body along with a large door resting on top to be moved about a floor or workspace like a cart. The door supporting apparatus along with large door 100 resting on first frame members 102 may be conveniently moved and/or transported as workflow requires.

As shown in FIG. 1B, the door supporting apparatus may implement brakes 120 to lock wheels 106 to facilitate movement of the door supporting apparatus between horizontal and vertical orientations as discussed above. In the presently illustrated embodiment, brakes 120 are implemented using retrofitted vice grip tools (e.g., welded to frame members of the door supporting apparatus) enabling a locking of wheels 106 by squeezing brakes 120 and locking brakes 120 by hand, and an unlocking of wheels 106 by releasing brakes 120. In another embodiment, a large door detached from hinges may be supported by a lift plate 114 that may be raised or lowered. Lift plate 114 is attached to a rotating sleeve 122, where rotating sleeve is rotatable about frame member 116 responsive to a torque applied to a handle 118. In one application, a torque may be applied to handle 118 to provide support for a large door as the door is being remove from the hinges. This may reduce risk of damage to hinges in the process of removal of the door and reduce the risk of injury to workers who may otherwise attempt to decouple hinges while the door is manually held in place. Additionally, Lift plate 114 in combination with rotating sleeve 122 and handle 118 may enable a convenient control of a vertical height of a door for positioning the door to be reattached at hinges to a door opening.

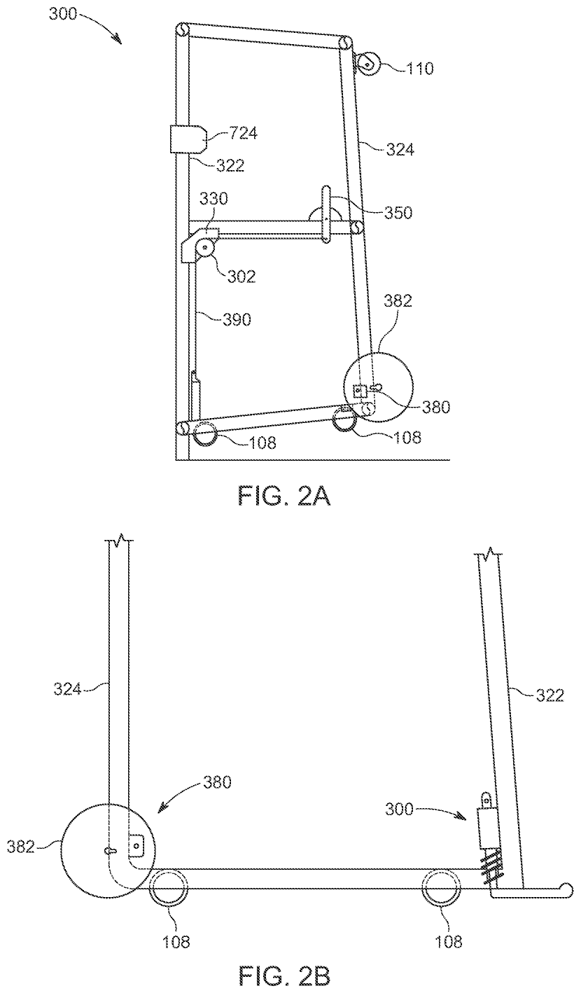

In one embodiment, as shown in FIG. 2A, a door supporting apparatus may implement a door left that is operated via a pulley 330. Here tension may be applied to or released from a cable 390 to raise or lower a lift assembly 300. Attached at foot lift 200, cable 390 may pass through a track in rotatable pulley wheel 302 and attach to lift handle 350. In a particular implementation, cable 390 may comprise a vinyl covered braided steel cable with slots formed at ends. Such slots may enable ends to be attached with hardened pins and/or keepers. As lift handle 350 is move forward towards first frame members 332, tension on pulley cable 390 is increased to thereby raise a door (not shown) placed on a foot lift (not shown) of lift assembly 300. As lift hand all 350 is moved backward away from first frame members 332 and toward frame members 334, tension on cable 390 may be reduced and/or released to thereby lower a door placed on the foot lift of lift assembly 300.

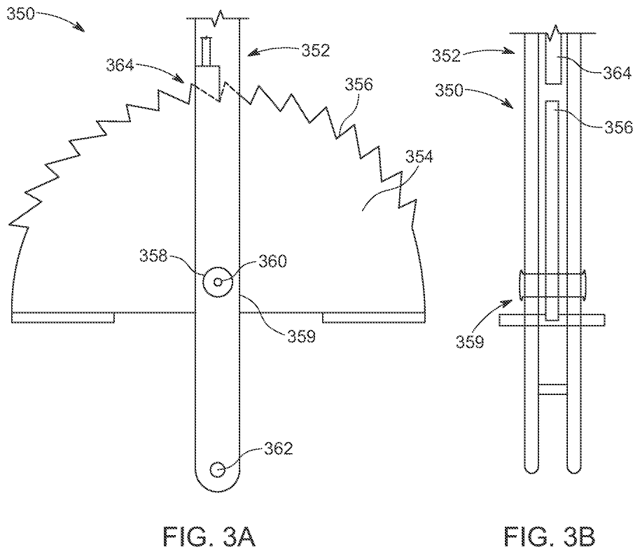

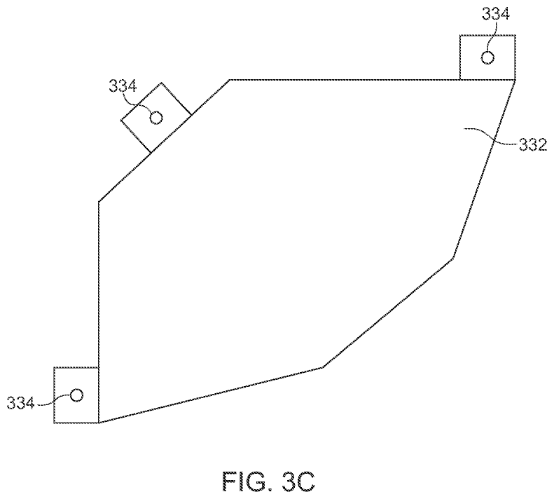

As shown in the particular implementation of FIGS. 3A and 3B, lift handle 350 may include a lever 352 attach to a stationary semicircular plate 354, where semicircular plate 354 may include teeth or jags 356. According to an embodiment, semicircular plate 354 may be integrated as part of an assembly that includes lever 352. Such an assembly integrating semicircular plate 354 and level 352 may be attached to mounting plates (e.g., mounting plates welded to frame members forming a carriage body such as 332 and/or 334) by bolts to facilitate replacement. Lever 352 may be attached to a frame member (not shown) of a door supporting apparatus at a pivot hole 358 using a pin 360. Lever 352 may also include a cable pinhole 362 to receive cable 390. A slot formed at an end of cable 390 may be fastened to lever 352 by hardened pins and/or keepers. Lever 352 may be rotated back and forth about pivot hole 358 to apply or release tension to cable 390 attached to lift cable pinhole 362, thereby raising or lowering a door resting on the foot lift of lift assembly 300.

As lever 352 is moved forward or backward to apply or release tension on cable 390, lever 352 may be locked in place by retractable catch 364. In one implementation, retractable catch 364 may be spring loaded so as to prevent unexpected release from a tooth or jag 356. As shown retractable catch 364 may be moved toward or away semi circular plate 354 to engage a tooth or jag 356. For example lever 352 may be moved to be rotated about pivot hole 358 for raising a heavy door to a desired vertical height. Once the heavy door is raised to desired vertical height, catch 364 maybe moved toward semicircular plate 354 to engage a tooth or jag 356, thereby locking in the desired vertical height of the heavy door.

According to an embodiment, pulley 330 may include a pulley cover 332 shown in FIG. 3C. Pulley cover 332 bait include flanges with holes 334 formed therein to enable attachment of pulley cover 332 to frame members of the door supporting apparatus using bolts, rivets or other attachment hardware. Pulley cover 332 and pulley wheel 302 may be attached to a mounting plate (e.g., welded to frame members of a carriage body such as frame members 322 and/or 324) by bolts to facilitate replacement.

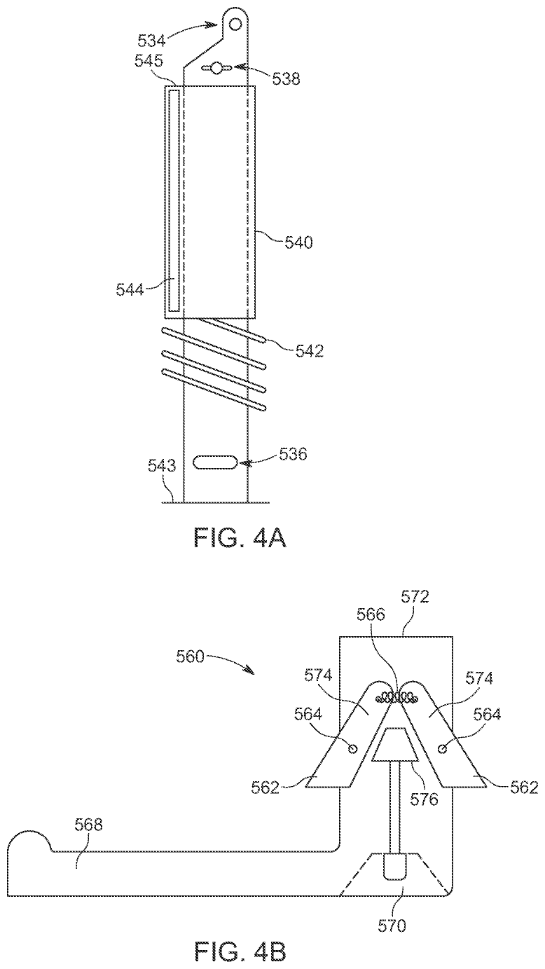

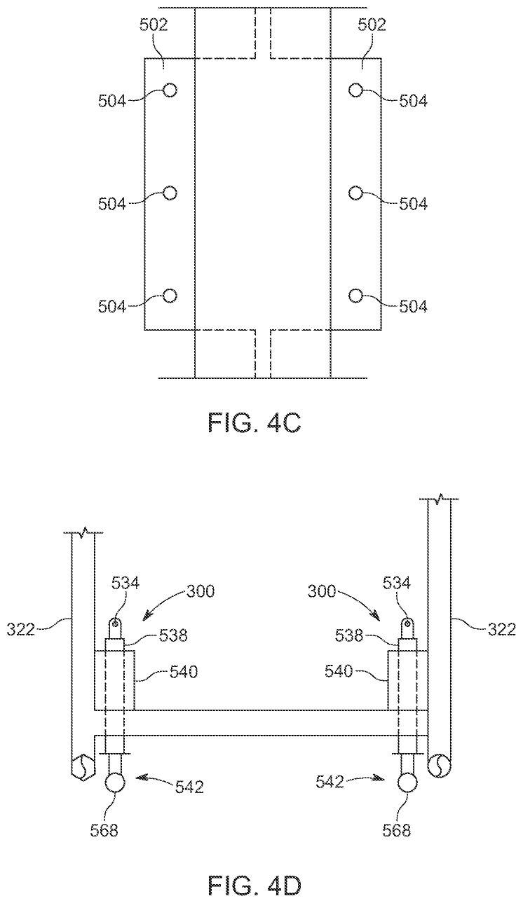

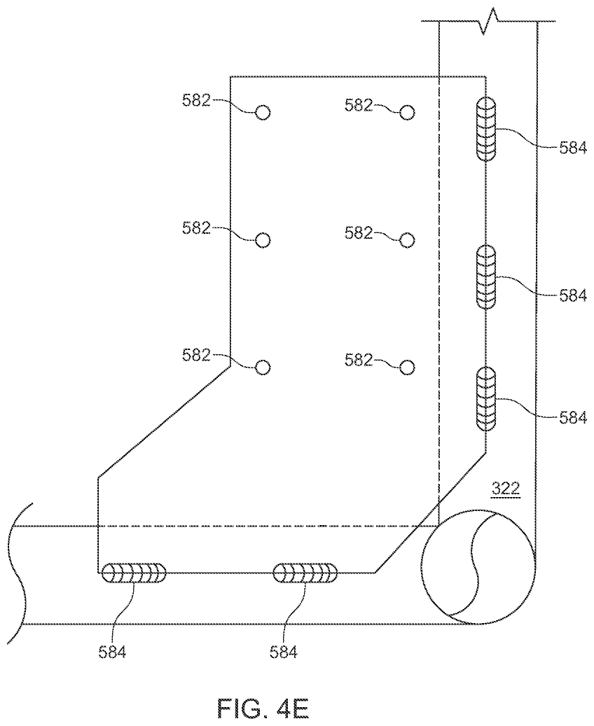

FIG. 4D shows an embodiment that includes two list assemblies 300 each controlled by an independent pulley system such as a pulley system implemented by a corresponding lift handle 350, a corresponding pulley wheel 302, and a corresponding cable 390. In a particular implementation, a lift foot 568 may be couple to each of two lift assemblies 300 such that a lower side of a heavy door may rest on lift feet 568 (e.g., while a door supporting apparatus is in a vertical position/orientation). Independently controlling the height of each lift foot 568 by independent pully systems, a heavy door may be properly leveled while positioning the heavy door to be placed on hinges. Lift assemblies 300 may be attached to first frame members 322.

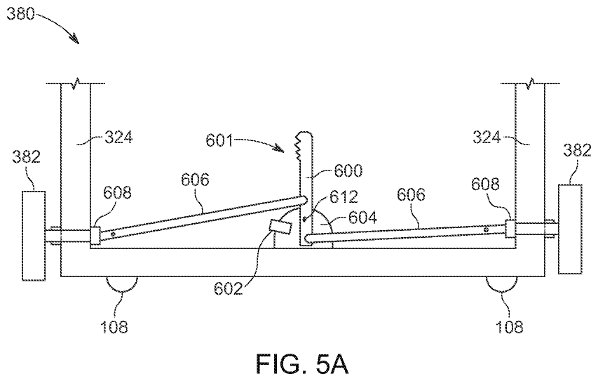

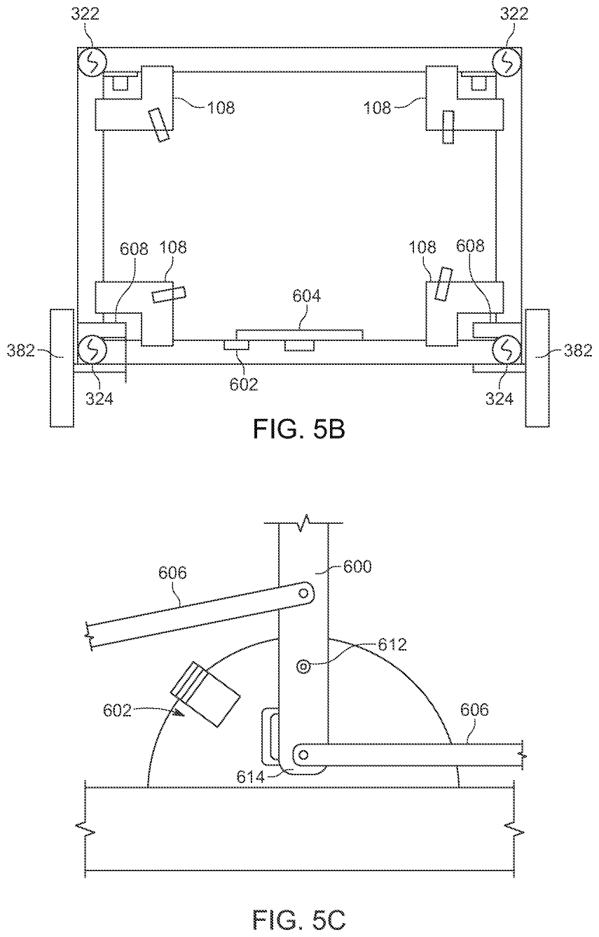

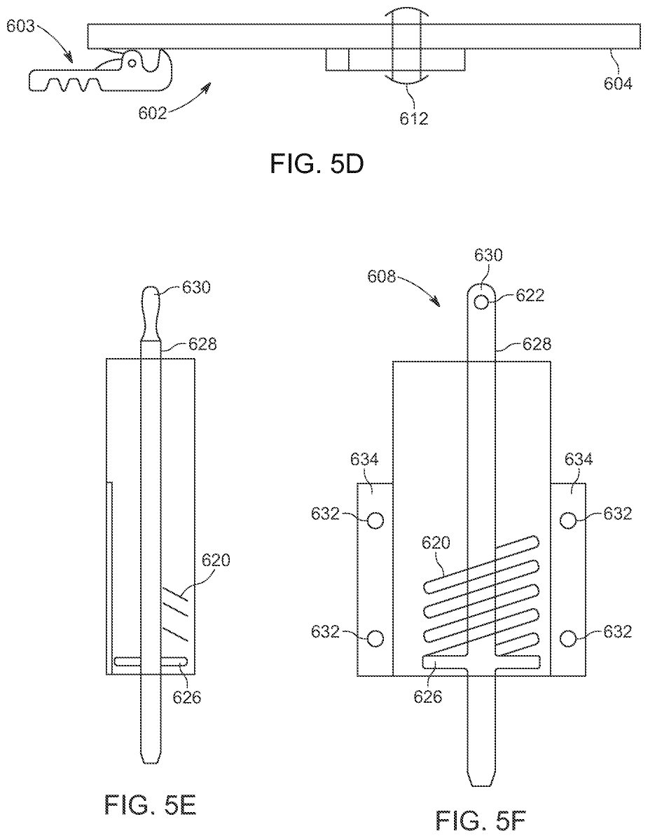

According to an embodiment as shown in FIG. 4A, lift assembly 300 may include an inner metal tube 538 including an attachment hole 534 formed therein to receive cable pulley 390. A foot lift (not shown) maybe attached to slot 536 formed within inner metal tube 538. According to an embodiment, inner metal tube 538 may move vertically responsive to application and release tension on pulley cable 390 (e.g., applied at handle 350) within outer metal tube 540. In a particular implementation, outer metal tube 540 maybe fixedly attached to a framed member of the door supporting apparatus (see, e.g., FIG. 4D). A spring 542 may be disposed to rest between inner metal tube 538 and outer metal tube 540. Movement of spring 542 may be limited by spring stop 543 at one end and by an edge 545 formed at a top portion of outer metal tube 540. A high-density polyethylene (HDPE) member 544 (e.g., 0.25 inch thickness) may be disposed between outer metal tube 540 and spring 542 to reduce friction from movement of spring 542 within outer metal tube 540. On a surface of HDPE member 544 facing spring 542, the surface of HDPE member 544 may be lubricated to facilitate movement of spring 542 while tension is applied or released from a cable 390 (FIG. 2). HDPE member 544 may be held in place by notches (not shown) formed within outer metal tube 540, and may be easily removed for re-lubrication and/or replacement due to wear. HDPE member 544 may comprise a self-lubricating member. In particular implementations, as noted above, assemblies, such as a brake assembly shown in FIGS. 5A through 5F, a lift assembly shown in FIGS. 4A through 4D and pulley assembly 3A through 3C, may be attached by bolts to holes formed in one or more mounting plates welded to frame members of a carriage body. This may facilitate easy replacement of assembly parts as consumables.

According to an embodiment, lift assembly 300 may be mounted to a frame member of the door supporting apparatus as shown in FIG. 4C. Here, middle flanges 502 may extend laterally and include holes 504 which may receive mount screws or rivets, etc. Holes 504 may be formed at a diameter of five sixteenths inches, but other diameters may be used to accommodate proper fasteners. According to an embodiment, holes 504 may be aligned with holes 582 formed in mount plate 580. Here, mount plate 508 may be attached to framed members of the door supporting apparatus (such as a frame member 322) by spot welds 584. Bolts placed through holes 504 aligned with holes 528 may secure a lift assembly 300 to the door supporting apparatus.

Referring again to FIGS. 2A and 2B, the carriage frame including first and second frame members 322 and 324 may enable movement of the door supporting apparatus while in an vertical orientation. To facilitate safe transition of the door supporting apparatus while transitioning between a horizontal orientation and a vertical orientation (e.g., while a heavy door being supported against first frame members 322), brake assemblies 380 may be engaged to selectively lock and unlock wheels 382. Brake assemblies 380 be in a locked state (e.g., preventing rotation of wheels 382) to support safe transition of door supporting apparatus between horizontal and vertical orientations, and may be placed in an unlocked state to enable movement of a heavy door about a workspace.

FIGS. 5A and 5B show an example implementation of brake assemblies 380. As shown, handle 600 may be coupled to linkages 606 at opposite points of a pivot pin 612 securing handle 600 to mount plate 604. In a particular implementation, linkages 606 may be formed as round metal bars (e.g., steel or aluminum). Each linkage 606 may comprise a slot in each end and a hole drilled through. Linkages 606 may be connected with hardened pins and/or keepers. Components such as handle 600, mount plate 604 and brake stop 602 may be integrated into an assembly that may be attached to a mounting plate (e.g., welded to frame members such as frame members 322 or 324) by bolts to facilitate convenient replacement of the entire integrated assembly. As shown in FIG. 5A, brake assembly 380 is in a locked state with spring assemblies 608 applying a brake stop to respective wheels 382. As shown in FIG. 5B, spring assemblies 608 may be mounted to second frame members 324. Also, mount plate 604 may be secured to a frame member 623 connected between second frame members 324.

Brake assembly 380 may be transitioned to an unlocked state by pushing or moving handle 600 indirection 601 until a lower portion of handle 600 engages break stop 602. As shown in the top view of FIG. 5D, as end 614 of handle 600 rotates about pivot pin 612, end 614 of handle 600 may slip under spring-loaded catch 602 to prevent movement of handle 600 while brake assembly 380 is in an unlocked position (e.g., to allow free movement of wheels 382).

FIGS. 5E and 5F are drawings of views of spring assembly 608 according to an embodiment. Metal flat flange 634 may be adapted to be placed against a second frame member 324 (FIG. 5A). Spring assembly 608 may then be affixed to second frame member 324 by screws, bolts or other fasteners inserted through whole 632. For example, spring assembly 608 may be attached to a mounting plate (e.g., welded to a frame member of a carriage body) by bolts to facilitate convenient replacement. Piston member 628 may be disposed within housing 621 and be able to freely move in a direction toward or away from wheel 382 (FIG. 5A). Spring 620 disposed within housing 621 may apply a force to press a stop 626 of piston member 628 against wheel 382, creating a static friction against a surface of wheel 382 that prevents wheel 382 from rotating. A linkage 606 (FIG. 5A) may be connected to a top portion 630 of piston member 628 at an attachment hole 622 by a screw or other fascinating means. Linkages 606 may be fastened to attachment holes 622 of respective spring assemblies 608 by hard pins and/or keepers. In an implementation, while linkage 606 pulls piston member 628 in a direction away from wheel 382 (e.g., if handle 600 is pushed in a direction 601 such that lower end 614 of handle 600 is secured at catch 602 (FIGS. 5A and 5C), stop 626 may be pulled away from wheel 382 under tension from spring 620, allowing wheel 382 to freely rotate. If catch 602 if subsequently released (e.g., by a kick from a user), handle 600 may be allowed to freely rotate and force from spring 620 may returned the stop 626 to a surface of wheel 382 to prevent rotation of the wheel.

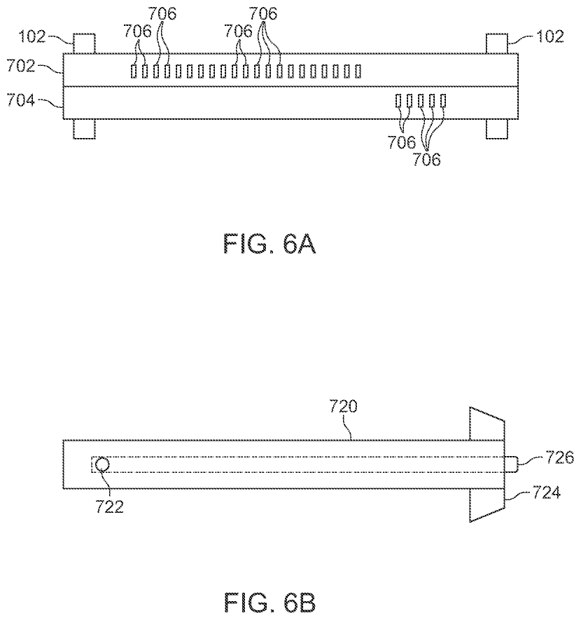

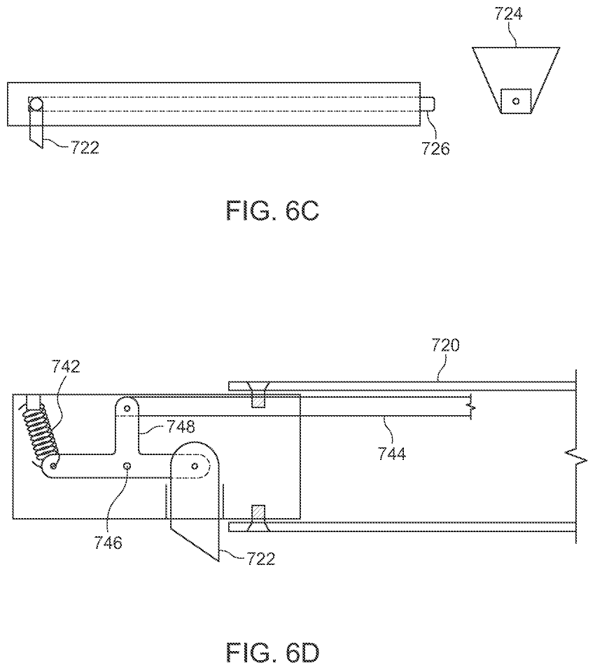

FIGS. 6A through 6D are schematic diagrams of features of a support arm assembly, such as support arm assembly 111 shown in FIG. 1E, according to an embodiment. Support arm assembly 111 may include opposing adjustable arms 720, each adjustable arm 720 to be attached to a clamping attachment 724 to abut a lateral edge of large door 100 to secure large door 100 in place while the door supporting apparatus transitions between horizontal vertical orientations. By securing large door 100 in place, support arm assembly 111 may reduce injury and facilitate positioning of large door 100 while attaching large door 100 to or removing large door 100 from hinges at a door opening.

According to an embodiment, upper tube housing 702 and lower tube housing 704 maybe secured to frame members 102 by welding joints, for example. Upper tube housing 702 may be adapted to receive a first adjustable arm 720 and lower tube housing 704 may be adapted to receive a second adjustable arm 720. Opposing adjustable arms 720 may be positioned within respective upper tube housing 702 and lower tube housing 704 to provide opposing forces against lateral sides of large door 100 to secure large door 100 in place. According to an embodiment, upper tube housing 702 and lower tube housing 704 may each be formed as a cylindrical metal tube having an inner diameter to slidably receive an inserted adjustable arm 720. A spring-loaded peg 722 of an inserted adjustable arm 720 may be positioned in an appropriate hole 706 to lock the inserted adjustable arm 720 at a suitable depth within tube housing 702 or 704. Here, it should understood that such a suitable depth may be determined based on a width of a door that is to be supported and a required separation of opposing clamping attachments 724 to be positioned on lateral edges of the door.

According to an embodiment, tube housings 702 and 704 may receive an adjustable arm 720 at either opening (e.g., left or right opening) to accommodate positioning of hinge hardware on at least one lateral edge of a supported door. In one application, for example, a left-extending adjustable arm 720 may be inserted in upper tube housing 702 while a right-extending adjustable arm 720 may be inserted in lower tube housing 704. In another application, a left-extending adjustable arm 720 may be inserted in lower tube housing 704 while a right-extending adjustable arm 720 may be inserted in upper tube housing 702.

As shown in FIGS. 6A and 6B, an adjustable arm 720 may include a spring loaded peg 722 spring-loaded that may be placed in an appropriate hole 706 to lock the adjustable arm 720 in position. Spring-loaded peg 722 may be retracted by application of pressure to release button 726 to remove spring-loaded peg 722 from the hole 726, thereby unlocking the adjustable arm 720. Spring-loaded peg 722 may then be extended through different hole 706 by release of release button 726 to lock the adjustable arm 720 at a different depth within upper tube housing 702 or lower tube housing 704. FIG. 6C shows an adjustable arm separated from an associated clamping attachment 724. In the particular implementation of FIG. 6D, arm locking assembly 704 may be attached to an adjustable arm 720 with screws. Linkage 744 may be coupled to release button 726 (FIGS. 6B and 6C) and may be attached to T-member 748. T-member 748 may also be attached to spring 742 and spring-loaded peg 722, and may rotate about pivot point 746 responsive to pressure applied to or released from release button 726.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A door supporting apparatus, comprising:
a carriage body, the carriage body comprising one or more first frame members to be placed against a face of a vertically installed door, and one or more second frame members opposite the one or more first frame members; and
one or more wheels attached to the carriage body such that, while a face of a detached door in a vertical orientation is positioned against the one or more first frame members, the carriage is rotatable about at least one of the one or more wheels to place the one or more second frame members against a floor and place the detached door in a substantially horizontal orientation.

2. The door supporting apparatus of claim 1, and further comprising a brake coupled to the one or more wheels, and wherein:
the one or more wheels freely rotate about an associated one or more axles while the brake is in an unlocked state; and
the one or more wheels are prevented from rotation about the associated one or more axles while the brake is in a locked state such that carriage body rotates about a point of contact of the one or more wheels with the floor while the door transitions between the vertical orientation and horizontal orientation.

3. The door supporting apparatus of claim 2, wherein the brake further comprises:
one or more stops to be pressed against surfaces of the wheels by springs while the brake is in the locked position; and
a handle coupled to the one or more stops by linkages, wherein:
the handle is configured to move linkages away from the wheels against tension of the springs and to be locked in position by a catch to place the brake in an unlocked position; and
while the brake is in the unlocked position, the springs are to return the one or more stops to be pressed against the surface of the wheels to place the brake in the locked position responsive to release of the handle from the catch.

4. The door supporting apparatus of claim 3, wherein the linkages are coupled to the handle at opposite ends of a pivot point of attachment of the handle to a housing.

5. The door supporting apparatus of claim 1, and further comprising two or more handles attached to the carriage body to control vertical positioning of the detached door while in the face of the detached door is positioned against the one or more first frame member, wherein:
a first handle of the one or more handles controls a vertical position of a first foot lift assembly to support weight of the detached door at a first point of contact;
a second handle of the one or more handles controls a vertical position of a second foot lift assembly to support the weight of the detached door at a second point of contact; and
the vertical positions of the first and second foot lift assemblies are independently controllable by the first and second handles to independently vary vertical positions of the first and second points of contact with the detached door.

6. The door supporting apparatus of claim 5, and further comprising first and second pulley systems, wherein:
the first pulley system to couple the first handle to the first foot lift assembly by a first cable; and
the second pulley system to couple the second handle to the second foot lift assembly by a second cable.

7. The door supporting apparatus of claim 5, wherein each of the first and second foot lift assemblies further comprise a metal tube with a slot formed therein to receive a detachable foot to provide an associated point of contact with the detached door.

8. The door supporting apparatus of claim 1, and further comprising one or more casters attached to the one or more second frame members such that the one or more casters and at least one of the one or more wheels are in contact with the floor while the detached door is in the substantially horizontal orientation.

9. The door supporting apparatus of claim 1, and further comprising:
one or more tube housings; and
first and second opposing adjustable arms disposed in the one or more tube housings, the first and second opposing adjustable arms to apply opposing forces at lateral edges of the detached door to stabilize the detached door in the door supporting apparatus.

10. The door supporting apparatus of claim 9, wherein:
the first opposing adjustable arm is adapted to apply a first force to a first lateral edge of the detached door and the second opposing adjustable arm is adapted to apply a second force to a second lateral edge of the detached door;
the one or more tube housings comprise at least an upper tube housing and a lower tube housing attached to the first frame members; and
the upper tube housing is adapted to receive an opposing adjustable arm to be extended to either the first lateral edge of the detached door or the second lateral edge of the detached door.

11. The door supporting apparatus of claim 9, wherein:
the one or more tube housings comprise an inner diameter to receive the first and second opposing adjustable arms; and
the first and second opposing adjustable arms comprise a spring-loaded mechanism to lock the first and second opposing adjustable arms at a depth within a tube housing.

12. The door supporting apparatus of claim 11, wherein the spring-loaded mechanism comprises:
a peg adapted to be extended in a hole formed in a tube housing;
a linkage extending to a button on an exterior of an opposing adjustable arm;
a pivoting member attached to a spring, the peg and the linkage, the pivoting member to retract the peg from the hole responsive to pressure applied to the button and extend the peg through the hole responsive to release of pressure applied to the button.

13. A method comprising:
supporting a door detached from a vertical installation on door supporting apparatus comprising a carriage body and one or more wheels affixed to the carriage body, the carriage body comprising one or more first frame members to be placed against a face of a vertically installed door, and one or more second frame members opposite the one or more first frame members the one or more wheels being rotatable about one or more associated axels;
locking the one or more wheels to prevent rotation about the associated axles; and
rotating the carriage body about points of contact of the one or more wheels while in contact with a floor to place the detached door in a horizontal orientation.

14. The method of claim 13, wherein:
the door supporting apparatus further comprises one or more casters attached to the one or more second frame members; and
the one or more casters are in contact with the floor while the detached door is in the horizontal orientation, the method further comprising:
unlocking the one or more wheels; and
moving the carriage body in a work area while the one or more wheels and one or more casters roll while in contact with the floor.

15. The method of claim 13, and further comprising:
rotating the carriage body about points of contact of the one or more wheels with the floor to return the detached door to a vertical orientation from the horizontal orientation; and
independently adjusting the height of multiple points of the detached door to position the detached door for attachment at an opening.

16. A method comprising:
supporting a door detached from a vertical installation on door supporting apparatus comprising a carriage body;
adjusting a first handle attached to the carriage body to control a vertical position of a first foot lift assembly to support weight of the detached door at a first point of contact; and
adjusting a second handled attached to the carriage body to control a vertical position of a first foot lift assembly to support weight of the detached door at a first point of contact, wherein the vertical positions of the first and second foot lift assemblies are independently controllable by the first and second handles to independently vary vertical positions of the first and second points of contact with the detached door.

17. The method of claim 16, wherein:
the first handle is coupled to the first foot lift assembly by a first cable through a first pulley system; and
the second handle is coupled to the second foot lift assembly by a second cable through a second pulley system.

18. The method of claim 16, wherein each of the first and second foot lift assemblies further comprise a metal tube with a slot formed therein to receive a detachable foot to provide an associated point of contact with the detached door.
